(19) United States
(12) Patent Application Publication
(10) Pub. No.: US 2013/0204575 A1
(43) Pub. Date: Aug. 8, 2013

(54) SYSTEMS AND METHODS FOR ESTIMATION OF BUILDING FLOOR AREA

(71) Applicant: Chris Pershing, Redmond, WA (US)

(72) Inventor: Chris Pershing, Redmond, WA (US)

(21) Appl. No.: 13/385,607

(22) Filed: Feb. 3, 2012

(51) Int. Cl. G01B 21/28; G06F 17/00

(52) U.S. Cl. CPC G01B 21/28; G06F 17/00
USPC 702/156

(57) ABSTRACT

A system generates an estimated floor area measurement of a building based on the calculated estimated total roof area of the roof of the building. This is based on a correlation between the size of the building roof and the size of the building. Typically, the floor area of a single full floor of the building is roughly the size of the roof of the building if the roof were flat with no slope (i.e., virtually turning the roof into another floor to generate estimated floor area). With additional adjustments to area measurements to account for multiple floors, roof overhang, wall width, internal building features such as walls and staircases, and/or obstructed views of the building in the aerial image(s), etc., an even more accurate floor area estimation may be generated.

### BACKGROUND

1. Technical Field

This invention is in the field of building size estimation, and in particular, building floor area estimation.

2. Description of the Related Art

Building floor area is used throughout the construction, real estate, insurance and finance industries. For example, the square footage measurement of a building is used as a main factor in quickly determining the market value of real estate, estimating costs of materials to repair or replace flooring and make other improvements or modifications to the entire building. Thus, accurate floor area measurements are instrumental in these calculations. Current methods of measuring floor area often involve a person having to visit the building and manually measure particular dimensions within the building, or by referring to original plans or blueprints of the building. Manually measuring the dimensions for verification of building floor area is costly and original plans for the building may be unavailable or out of date. Therefore, accurate methods for estimating and verifying floor area that avoid these drawbacks are desirable.

### SUMMARY OF THE INVENTION

In one embodiment, a floor area measurement system receives a first and a second aerial image of the building, each of the aerial images providing a different view of the roof of the building. The system correlates the first aerial image with the second aerial image to generate a three-dimensional model of the roof that includes a plurality of planar roof sections that each have a corresponding slope, area, and edges. An adjusted roof model is generated by adjusting a slope of the planar roof sections in the three dimensional model of the roof to substantially zero. This may be performed in a variety of manners, including, for example, removing particular roof features from the model that would not be present in a flat roof with no slope (i.e., “fusing” individual planar roof sections in the model into one flat roof section), such as by removing ridge lines or other features distinguishing individual planar roof sections. This may be performed instead of or in addition to adjusting a slope parameter or variable of each roof section within the roof model to zero. In other embodiments, this step may be performed with just one initial aerial image of the building showing a substantially orthogonal view of the building since roof pitch need not be determined and can be assumed to be zero.

The system generates the estimated floor area measurement of the building based on the calculated estimated total roof area of the roof after the roof model has been adjusted. This is based on a correlation between the size of the building roof and the size of the building. Typically, the floor area of a single full floor of the building is roughly the size of the roof of the building if the roof were flat with no slope (i.e., virtually turning the roof into another floor). With additional adjustments to the roof area measurements to account for multiple floors, roof overhang, wall width, internal building features such as walls and staircases, and/or obstructed views of the building in the aerial image(s), etc., an even more accurate floor area estimation is generated.

In one embodiment, a floor area measurement estimation system may be a system integrated with a roof estimation system or other system that provides roof measurements. In other embodiments, the roof area measurements may be provided by an external source, system or entity, or may be input manually by an operator of the floor area measurement estimation system. Various received roof measurements may often correspond closely to external dimensions of the building such as the width and length of the building and/or lengths of exterior walls or sections of exterior walls of the building.

### BRIEF DESCRIPTION OF THE SEVERAL VIEWS OF THE DRAWINGS

FIG. 1A is a flow diagram showing an example method of generating an estimated floor area measurement, according to one non-limiting illustrated embodiment.

FIG. 1B is a flow diagram showing a method that may be included as part of the generating floor area measurement step of the method shown in FIG. 1A, according to one non-limiting illustrated embodiment.

FIG. 1C is a flow diagram showing a method that may be included as part of the generating total roof area step of the method shown in FIG. 1B, according to one non-limiting illustrated embodiment.

FIG. 2 is an example screenshot of a user interface of a system for generating floor area measurements with roof sections annotated on an aerial image of the roof, according to one non-limiting illustrated embodiment.

FIG. 3 is an example screenshot of a user interface of the system of FIG. 2 for generating floor area measurements with area measurements of roof sections annotated on an aerial image of the roof, according to one non-limiting illustrated embodiment.

FIG. 4 is an example screenshot of a user interface of the system of FIG. 2 for generating floor area measurements showing the roof annotated with an estimated total roof area on which to base an estimated floor area measurement, such as that estimated in the method of FIGS. 1A-1C, according to one non-limiting illustrated embodiment.

FIG. 5 is an example screenshot of a user interface of the system of FIG. 2 for generating floor area measurements showing the building annotated with an adjusted estimated floor area measurement, such as that estimated in the method of FIGS. 1A-1C, according to one non-limiting illustrated embodiment.

FIG. 6 is an example screenshot of a user interface of the system of FIG. 2 for generating floor area measurements showing the building annotated with adjusted estimated first and second floor area measurements, such as that estimated in the method of FIGS. 1A-1C, according to one non-limiting illustrated embodiment.

FIG. 7 is an example screenshot of a user interface of the system of FIG. 2 for generating floor area measurements showing a line drawing of a top plan view of each the first and second floor of the building annotated with corresponding floor area measurements, such as that estimated in the method of FIGS. 1A-1C, according to one non-limiting illustrated embodiment.

FIG. 8 is an example screenshot of a user interface of the system of FIG. 2 for generating floor area measurements showing a line drawing of a top perspective view of the first and second floor of the building annotated with corresponding floor area measurements, such as that estimated in the method of FIGS. 1A-1C, according to one non-limiting illustrated embodiment.

FIG. 9 is a schematic diagram of a computing environment in which systems and methods for estimation of building floor area may be implemented or of which they may be a part.

### DETAILED DESCRIPTION

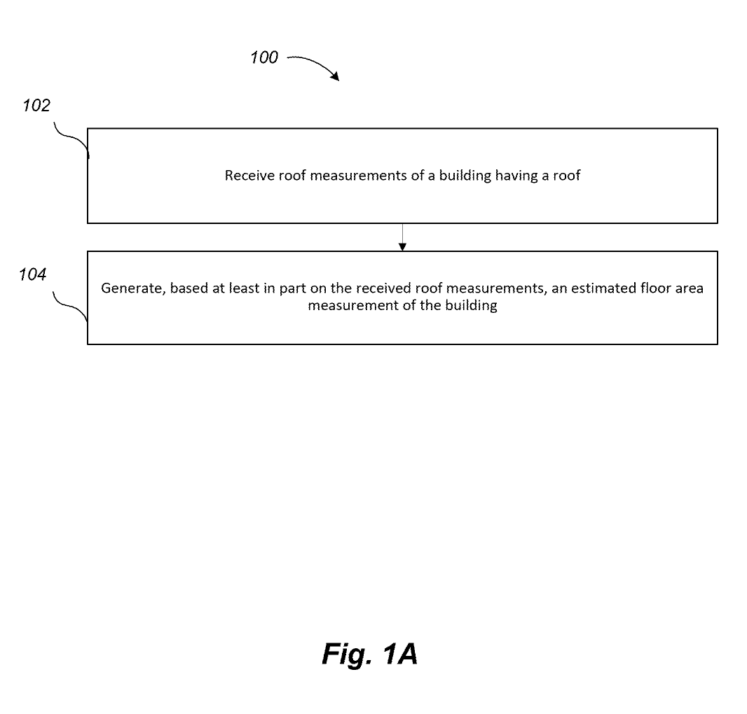

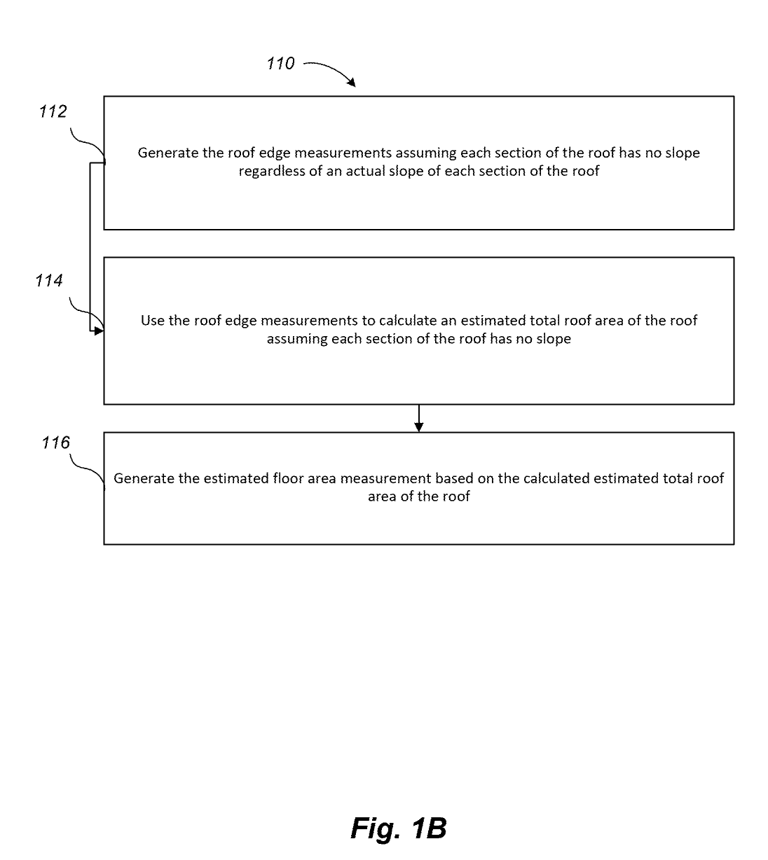

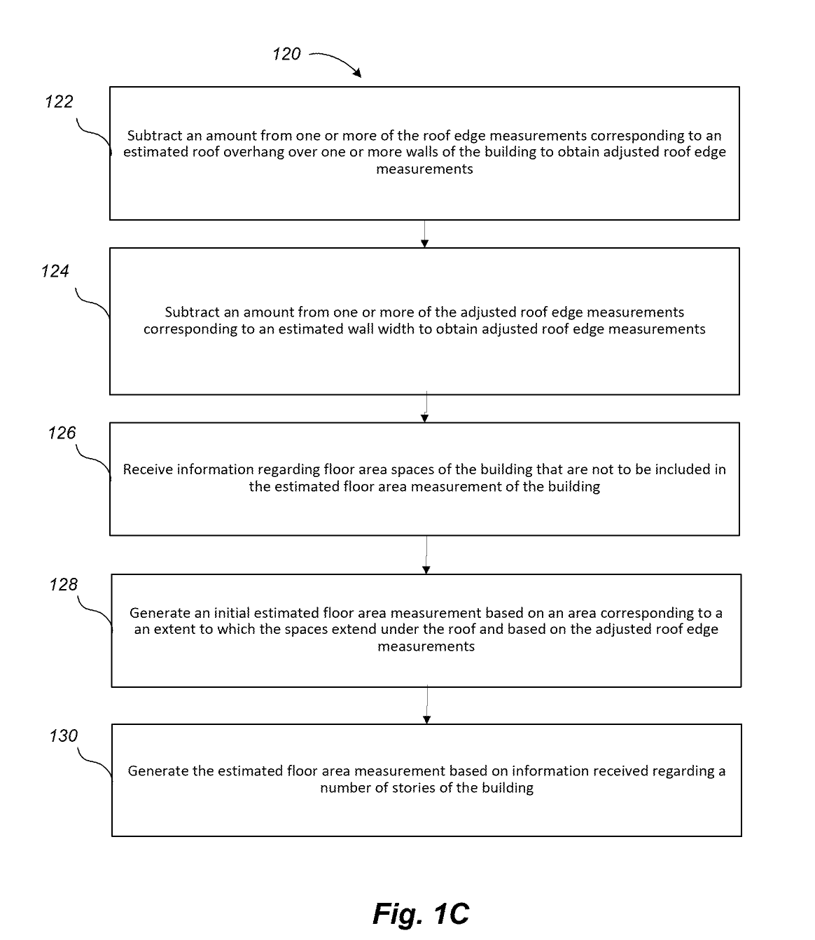

FIG. 1A is a flow diagram showing an example method 100 of generating an estimated floor area measurement, according to one non-limiting illustrated embodiment.

While each of the steps shown in FIG. 1A contributes to the overall solution, each can be used independently or in various combinations to yield improvements in estimating floor area measurements as discussed below. Below is an overview of each step in the process, which will be followed by a more detailed discussion of each step.

At 102, the process receives roof measurements of a building having a roof. These measurements may be estimated or actual dimensional and/or area measurements of the roof such as one or more of: roof edge lengths, ridge lengths, gable lengths, hip lengths, valley lengths, roof section pitch, roof area measurements, planar roof section area measurements, planar roof section dimension measurements, etc. These roof measurements may be generated internally by a component of a system that estimates floor area measurements (i.e., a floor area measurement estimation system) and received from such an internal component, or may be generated and received from an external component or entity separate from the floor area measurement estimation system. In some embodiments, the external component is located remotely from the floor area measurement estimation system.

For example, in some embodiments, the floor area measurement estimation system may be a system integrated with a roof estimation system or other system that provides roof measurements. In other embodiments, the roof area measurements may be provided by an external source, system or entity, or may be input manually by an operator of the floor area measurement estimation system. Various received roof measurements may often correspond closely to external dimensions of the building such as the width and length of the building and/or lengths of exterior walls or sections of exterior walls of the building.

At 104, the process generates, based at least in part on the received roof measurements, an estimated floor area measurement of the building. For example, the received roof measurements may include roof edge measurements of the roof. In such an embodiment, a floor area measurement estimation module of the floor area measurement estimation system is configured to generate, based at least in part on the received roof measurements, an estimated floor area measurement. In some embodiments, the received roof measurements may include roof area measurements. In some embodiments, the floor area measurement estimation module of the floor area measurement estimation system is configured to generate, based at least in part on the received roof area measurements, an estimated floor area measurement. For example, the roof measurements may be generated by the roof estimation system described in one or more of U.S. patent application Ser. No. 12/148,439 filed on Apr. 17, 2008 and entitled AERIAL ROOF ESTIMATION SYSTEM AND METHOD, U.S. Pat. No. 8,078,436 issued Dec. 13, 2011, and entitled AERIAL ROOF ESTIMATION SYSTEMS AND METHODS, U.S. patent application Ser. No. 12/467,244 filed May 15, 2009 and entitled PITCH DETERMINATION SYSTEMS AND METHODS FOR AERIAL ROOF ESTIMATION, U.S. patent application Ser. No. 12/467,250 filed May 15, 2009 and entitled CONCURRENT DISPLAY SYSTEMS AND METHODS FOR AERIAL ROOF ESTIMATION, U.S. patent application Ser. No. 13/019,228 filed Feb. 1, 2011 and entitled GEOMETRIC CORRECTION OF ROUGH WIREFRAME MODELS DERIVED FROM PHOTOGRAPHS and U.S. Provisional Patent Application Ser. No. ______ filed Feb. 3, 2012 (Attorney Docket No. 290115.410P1), which are each incorporated herein by reference in their entireties and such a roof estimation system may be integrated with the floor area measurement estimation system, or various components of the floor area measurement estimation system described herein.

In many such embodiments, one or more of the roof measurements are based on aerial photographs of the building via manual or automated analysis of roof features, such as by using the roof estimation system or modules described in one or more of U.S. patent application Ser. No. 12/148,439 filed on Apr. 17, 2008 and entitled AERIAL ROOF ESTIMATION SYSTEM AND METHOD, U.S. Pat. No. 8,078,436 issued Dec. 13, 2011, and entitled AERIAL ROOF ESTIMATION SYSTEMS AND METHODS, U.S. patent application Ser. No. 12/467,244 filed May 15, 2009 and entitled PITCH DETERMINATION SYSTEMS AND METHODS FOR AERIAL ROOF ESTIMATION, U.S. patent application Ser. No. 12/467,250 filed May 15, 2009 and entitled CONCURRENT DISPLAY SYSTEMS AND METHODS FOR AERIAL ROOF ESTIMATION, U.S. patent application Ser. No. 13/019,228 filed Feb. 1, 2011 and entitled GEOMETRIC CORRECTION OF ROUGH WIREFRAME MODELS DERIVED FROM PHOTOGRAPHS and U.S. Provisional Patent Application Ser. No. ______ filed Feb. 3, 2012 (Attorney Docket No. 290115.410P1). Thus, utilizing some embodiments described herein, one may estimate floor area measurements of a building merely using one or more aerial photographs of the building, with little or no additional information initially needed.

FIG. 1B is a flow diagram showing a method 110 that may be included as part of the generating floor area measurement step of the method shown in FIG. 1A, according to one non-limiting illustrated embodiment.

While each of the steps shown in FIG. 1B contributes to the overall solution, each can be used independently or in various combinations to yield improvements in estimating floor area measurements as discussed below.

At 112, the process generates roof edge measurements based on initial roof edge measurements included in the received roof measurements, assuming each section of the roof has no slope regardless of an actual slope of each section of the roof. For example, if the two edges of the gable of a pitched roof are 20 feet and the gable has a pitch angle of 90 degrees, then instead of two edges of 20 feet, the process generates a single roof edge of sqrt(800)˜28.3 feet. The process generates roof edge measurements as if the entire roof was flat.

At 114, the process uses the roof edge measurements to calculate an estimated total roof area of the roof assuming each section of the roof has no slope. Thus, the process generates roof area measurements as if the entire roof was flat.

In embodiments in which a roof estimation system is integrated with the floor area measurement system, the floor area measurement system first receives a first and a second aerial image of the building, each of the aerial images providing a different view of the roof of the building. The system correlates the first aerial image with the second aerial image to generate a three-dimensional model of the roof that includes a plurality of planar roof sections that each have a corresponding slope, area, and edges. In this embodiment, an adjusted roof model is generated by adjusting a slope of the planar roof sections in the three dimensional model of the roof to substantially zero. This may be performed in a variety of manners, including, for example, removing particular roof features from the model that would not be present in a flat roof with no slope (i.e., “fusing” individual planar roof sections in the model into one flat roof section), such as by removing ridge lines, valleys or other features distinguishing individual planar roof sections. This may be performed instead of or in addition to adjusting a slope parameter or variable of each roof section within the roof model to zero. In other embodiments, this step may be performed with just one initial aerial image of the building showing a substantially orthogonal view of the building since roof pitch need not be determined and can be assumed to be zero.

At 116, the process generates the estimated floor area measurement based on the calculated estimated total roof area of the roof. This is based on a correlation between the size of the building roof and the size of the building. Typically, the floor area of a single full floor of the building is roughly the size of the roof of the building if the roof were flat with no slope (i.e., virtually turning the roof into another floor). With additional adjustments to the roof area measurements described below (e.g., with respect to FIG. 1C) to account for multiple floors, roof overhang, wall width, internal building features such as walls and staircases, and/or obstructed views of the building in the aerial image(s), etc., an even more accurate floor area estimation is generated.

In other embodiments, the received roof measurements may instead or additionally include at least one of: a plurality of dimensional measurements of a two-dimensional outline of the roof from a top plan view of the roof and an area of the two-dimensional outline of the roof from the top plan view of the roof. In such instances, the dimensions of the two-dimensional outline of the roof from a top plan view of the roof may be used as the roof edge measurements on which to base the estimated floor area. However, these dimensional measurements of a two-dimensional outline of the roof need not be referred to as “roof edge measurements” or “roof measurements” to fall within the scope of the embodiments described herein.

FIG. 1C is a flow diagram showing a method 120 that may be included as part of the generating total roof area step of the method shown in FIG. 1B, according to one non-limiting illustrated embodiment. While each of the steps shown in FIG. 1C contributes to the overall solution, each can be used independently or in various combinations to yield improvements in estimating floor area measurements as discussed herein.

At 122, the process subtracts an amount from one or more of the roof edge measurements corresponding to an estimated roof overhang over one or more walls of the building to obtain adjusted roof edge measurements. For example, each roof edge measurement may be reduced (i.e., “eroded”) by 6 inches to 18 inches corresponding to an estimated roof overhang, which is selectable by a user of the floor area measurement estimation system. However, any variety of other lengths or ranges of lengths may be used including, for example a zero length or those of standard or typical roof overhang lengths.

At 124 the process subtracts an amount from one or more of the adjusted roof edge measurements corresponding to an estimated wall width to obtain adjusted roof edge measurements. For example, each roof edge measurement may be reduced (i.e., “eroded”) by 6 inches to 18 inches corresponding to an estimated wall width, which is selectable by a user of the floor area measurement estimation system. However, other lengths or ranges of lengths may be used (e.g., those of standard or typical wall widths).

At 126 the process receives information regarding floor area spaces of the building that are not to be included in the estimated floor area measurement of the building. For example, these areas may be areas of the building that are not used for living inside the building or areas outside the building including, but not limited to: garages; attics; unfinished rooms above the garage or other locations; covered balconies; patios, decks or porches, unfinished basements; crawl spaces; etc. This information may be received from an external system, source or entity; input by a user (e.g., identified or marked by a user on an image or drawing of the building displayed within a graphical user interface of the system); and/or automatically identified by the system via automated analysis of an image of the building.

At 128 the process generates an initial estimated floor area measurement based on an area corresponding to an extent to which the spaces that are not to be included in the estimated floor area measurement extend under the roof and based on the adjusted roof edge measurements. For example, the roof edge measurements may be used to calculate an estimated roof area with assumed slope of zero. Then, areas corresponding to an extent to which such spaces extend under the roof may be subtracted from the estimated roof area. This also may be performed automatically in response to a user marking or otherwise identifying such areas on an image or drawing of the building displayed within a graphical user interface of the system. In some embodiments, the entire process of generating an initial estimated floor area is automated by the system automatically recognizing these particular features in one or more images of the building through image analysis that utilizes typical characteristics of such features as viewed from the various angles of those in the one or more images of the building.

At 130, the process generates the estimated floor area measurement based on information received regarding a number of stories or floors of the building. For example, the floor area measurement estimation system may receive information regarding how many stories the building has and regarding one or more sections of the roof below which one or more of the stories extends. The system may then generate the estimated floor area measurement based on a total area of the one or more sections of the roof under which each of the stories extends and based on the generated estimated total roof area of the roof. This total area of the one or more sections of the roof under which each of the stories extends may be calculated using the adjusted roof edge measurements and then adjusted according to various other features of the building indentified in the an image of the building or otherwise received by the system. These various other features of the building indicate one or more sections of the roof below which one or more of the stories extends (e.g., such as features identifying split level homes, homes with lofts, vaulted ceilings, etc.).

The system may determine how many stories the building has using a second aerial image of the building representing a view from a different angle than the substantially orthogonal view of the top of the building such that the building height and other features related to how many stories the building has may at least be partially seen. This determination may be performed automatically in response to a user inputting a value representing the number of stories or by the user marking or otherwise identifying such areas corresponding to the different stories on an image or drawing of the building displayed within the graphical user interface of the system. The shape and perimeter of each building story may be annotated on a drawing or image of the building displayed in the graphical user interface and manipulated by a user of the system collectively and/or individually to make the adjustments described herein, (e.g., such as to indicate one or more sections of the roof below which one or more of the stories laterally extends). The estimated total floor area of the building is then calculated by adding the areas of each identified floor together to get the total area. The resulting changes in estimated total floor area are automatically generated by the floor area estimation system and displayed on the drawing or image of the building displayed in the graphical user interface.

In some embodiments, the entire process of generating an initial estimated floor area is automated by the system automatically recognizing these particular building features (e.g., building stories, floors, etc.) in one or more images of the building through image analysis that utilizes typical characteristics of such features as viewed from the various angles of those in the one or more images.

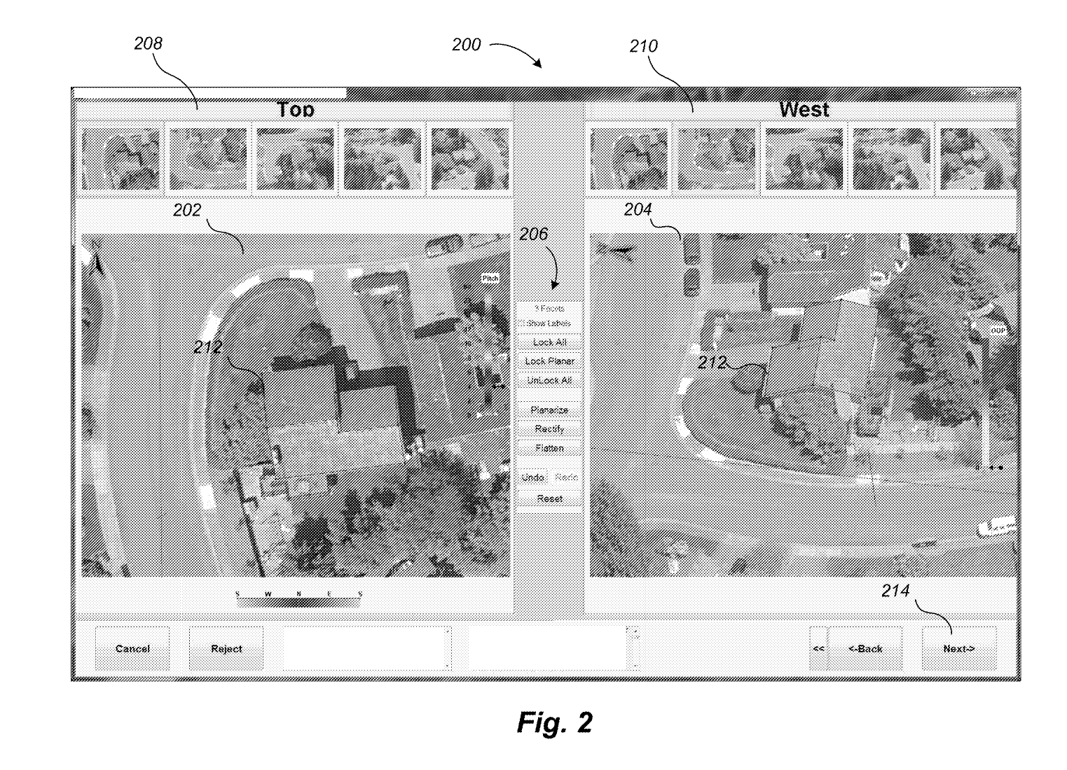

FIG. 2 is an example screenshot of a user interface of a system for generating floor area measurements with roof sections annotated on an aerial image of the roof, according to one non-limiting illustrated embodiment. For example, the screenshots of FIGS. 2-8 are screenshots of the graphical user interface of the floor area measurement system which performs the processes described in FIGS. 1A-1C above.

Shown is a graphical user interface including two panels, one with an image of a building showing a top substantially orthogonal view 202 of the building and the other with an image of the building showing a top oblique view 204 of the same building. Also shown is an annotation 212, which is a line drawing of a three dimensional model of the roof. The annotation 212 is an adjustable graphical user interface element overlaid on the roof of the building in each image corresponding to the angle of view 202 and view 204 of the roof in each image. The annotation 212 also shows various planar sections of the roof as delineated by the roof features and roof lines, such as the ridge line, valley lines and roof eaves, etc. This annotation 212 is an interactive graphical user interface feature and may be manipulated by a user of the system to make various adjustments to roof features and characteristics for the purpose of generating roof measurements, such as those used in the processes shown in FIGS. 1A-1C and other embodiment described herein. These may be performed by user interaction with the annotation itself and/or various selectable controls 206.

Also shown are image selection bars 208 and 210 which display thumbnail or reduced-size images of various other images showing the building from other perspectives and view angles. Selection bar 208 is located above view 202. When a particular thumbnail image in selection bar 208 is selected, the image showing the current view 202 is replaced with that of the selected image. Similarly, selection bar 210 is located above view 204. When a particular thumbnail image in selection bar 210 is selected, the image showing the current view 204 is replaced with that of the selected image.

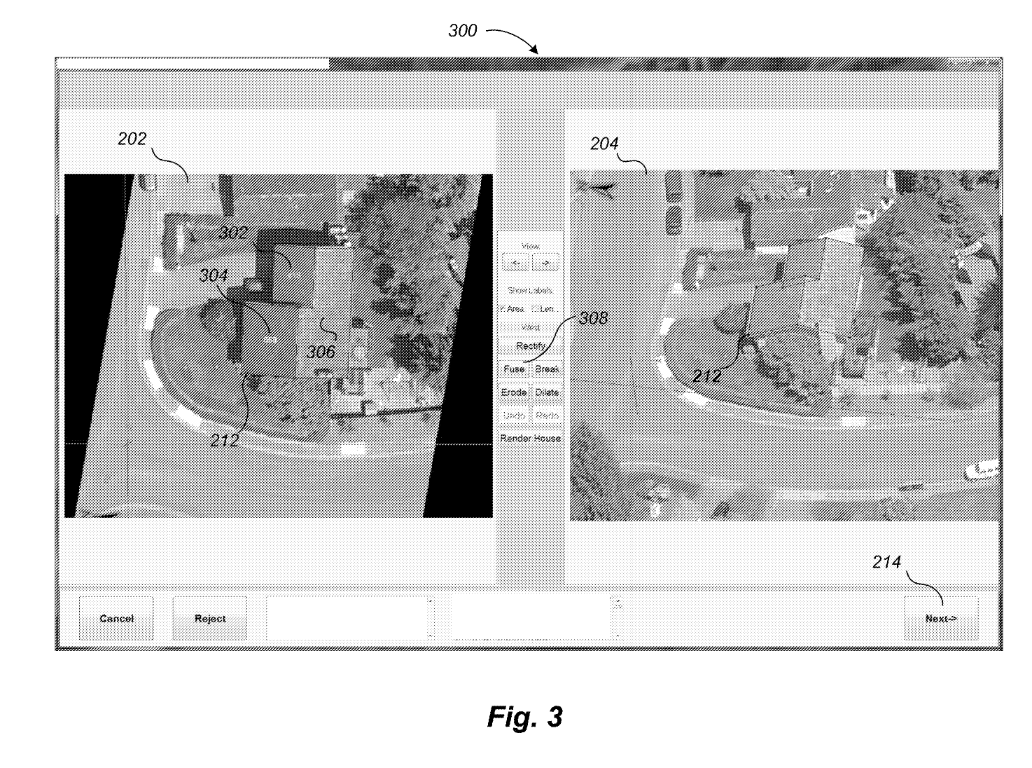

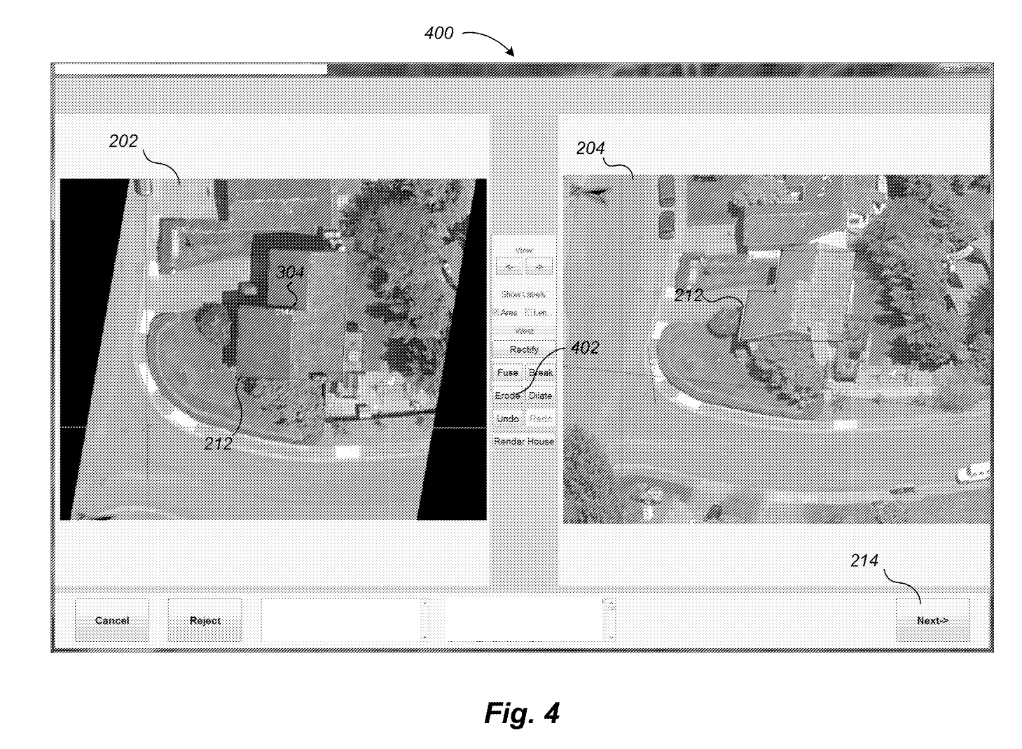

FIG. 3 is an example screenshot 300 of a user interface of the system of FIG. 2 for generating floor area measurements with area measurements 302, 304 and 306 of roof sections annotated on an aerial image of the roof, according to one non-limiting illustrated embodiment. For example, when the user selects the “next button” 214 shown in FIG. 2, the floor area measurement estimation system automatically calculates the areas 302, 304 and 306 of each roof section according to the roof annotation 212, as adjusted by the user, and displays these area values 302, 304 and 306 on the corresponding sections of the roof in the displayed image. Also shown in a “Fuse” button 308, the selection of which causes results to be displayed as shown in FIG. 4.

FIG. 4 is an example screenshot 400 of a user interface of the system of FIG. 2 for generating floor area measurements showing the roof annotated with an estimated total roof area 402 on which to base an estimated floor area measurement, such as that estimated in the method of FIGS. 1A-1C, according to one non-limiting illustrated embodiment. For example, when the user selects the “Fuse” button 308 shown in FIG. 3, the floor area measurement estimation system may perform the acts 112 and 114 of the process shown in FIG. 1B to calculate an estimated total roof area of the roof with an assumption that each section of the roof has no slope.

In this embodiment, the floor area measurement estimation system generates an adjusted roof model by adjusting the slope to substantially zero of the planar roof sections having areas 302, 304 and 306 shown in FIG. 3 in the three dimensional model of the roof represented by annotation 212. This may be performed in a variety of manners, including, for example, by automatically removing particular roof features from the model represented by annotation 212 in FIG. 3 that would not be present in a flat roof with no slope (i.e., “fusing” individual planar roof sections in the model into one flat roof section), such as by removing ridge lines or other features distinguishing individual planar roof sections instead of, or in addition to, adjusting a slope parameter or variable within the model to zero. This process results in the adjusted annotation 212 displayed by the system as shown in FIG. 4 without lines indicating roof features such as ridge lines associated the pitched roof. Thus, the system generates and provides roof edge measurements using the roof model as if the entire roof was flat with no slope, as shown by the annotation 212 representing the roof model in FIG. 4.

Although the screenshot of the graphical user interface 300 shows both the orthogonal view 202 and oblique view 204, in other embodiments, this action may be performed with just one initial aerial image of the building using and/or showing only the substantially orthogonal view 202 of the building since roof pitch need not be determined and can be assumed to be zero.

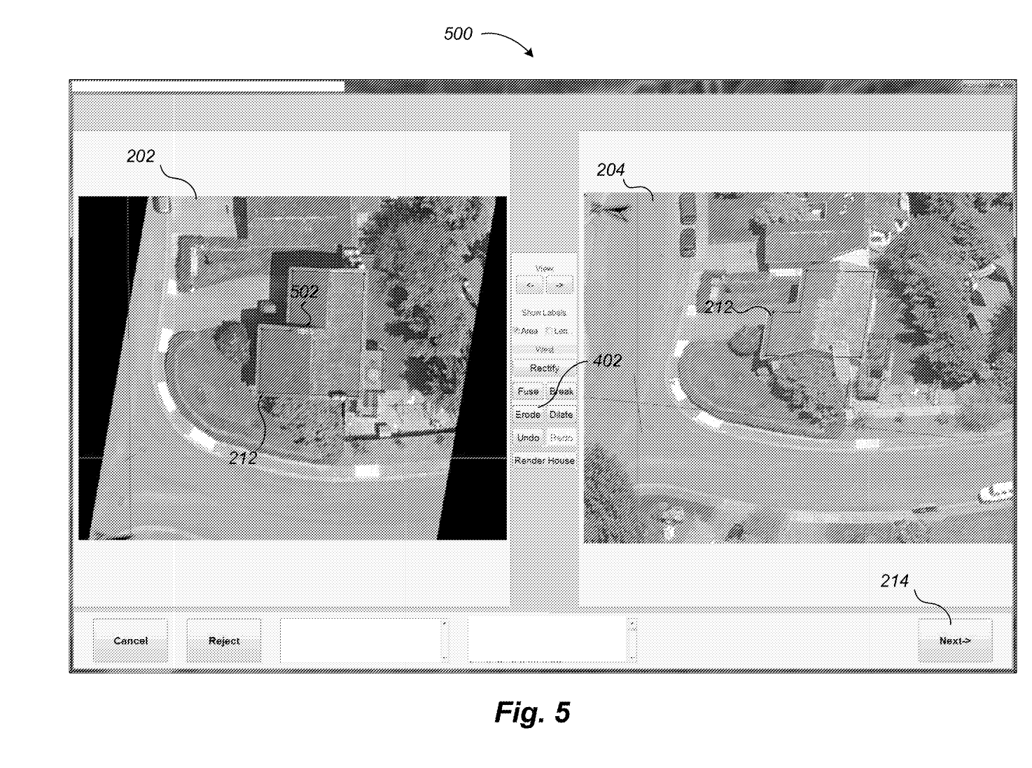

Also shown is an “Erode” button 402, the selection of which causes results to be displayed as shown in FIG. 5, as will be explained in conjunction with FIG. 5 below.

FIG. 5 is an example screenshot 500 of a user interface of the system of FIG. 2 for generating floor area measurements showing the building annotated with an adjusted estimated floor area measurement, such as that estimated in the method of FIGS. 1A-1C, according to one non-limiting illustrated embodiment. For example, when the user selects the “Erode” button 402 shown in FIG. 4, the floor area measurement estimation system may perform the acts 122 and 124 of the process shown in FIG. 1C to calculate an adjusted estimated total roof area of the roof assuming each section of the roof has no slope.

In this embodiment, the floor area measurement estimation system subtracts an amount from one or more of the roof edge measurements in the roof model represented by annotation 212 corresponding to an estimated roof overhang over one or more walls of the building to obtain adjusted roof edge measurements. For example, each roof edge measurement may be reduced (i.e., “eroded”) by 6 inches to 18 inches corresponding to an estimated roof overhang, which is selectable by a user of the floor area measurement estimation system. However, other lengths or ranges of lengths may be used.

The floor area measurement estimation system may also subtract an amount from one or more of the adjusted roof edge measurements in the roof model represented by annotation 212 corresponding to an estimated wall width to obtain adjusted roof edge measurements. For example, each roof edge measurement may be reduced (i.e., “eroded”) by 6 inches to 18 inches corresponding to an estimated wall width, which is selectable by a user of the floor area measurement estimation system. However, other lengths or ranges of lengths may be used.

In some embodiments, each time a user selects the “erode” button 402, an additional adjustment shortening the lengths of the roof edges (e.g., by 6 inches to 18 as selected by the user) will be performed by the system. Note that the annotation 212 in FIG. 5 is now adjusted corresponding to the adjusted roof edge lengths such that the actual edges of the roof in the image shown in both the orthogonal view 202 and oblique view 204 extend beyond the borders of the annotation 212. The corresponding roof area measurement 502 is also automatically adjusted accordingly by the floor area measurement estimation system (e.g., from 2144 square feet down to 1855 square feet as shown in FIGS. 4 and 5, respectively).

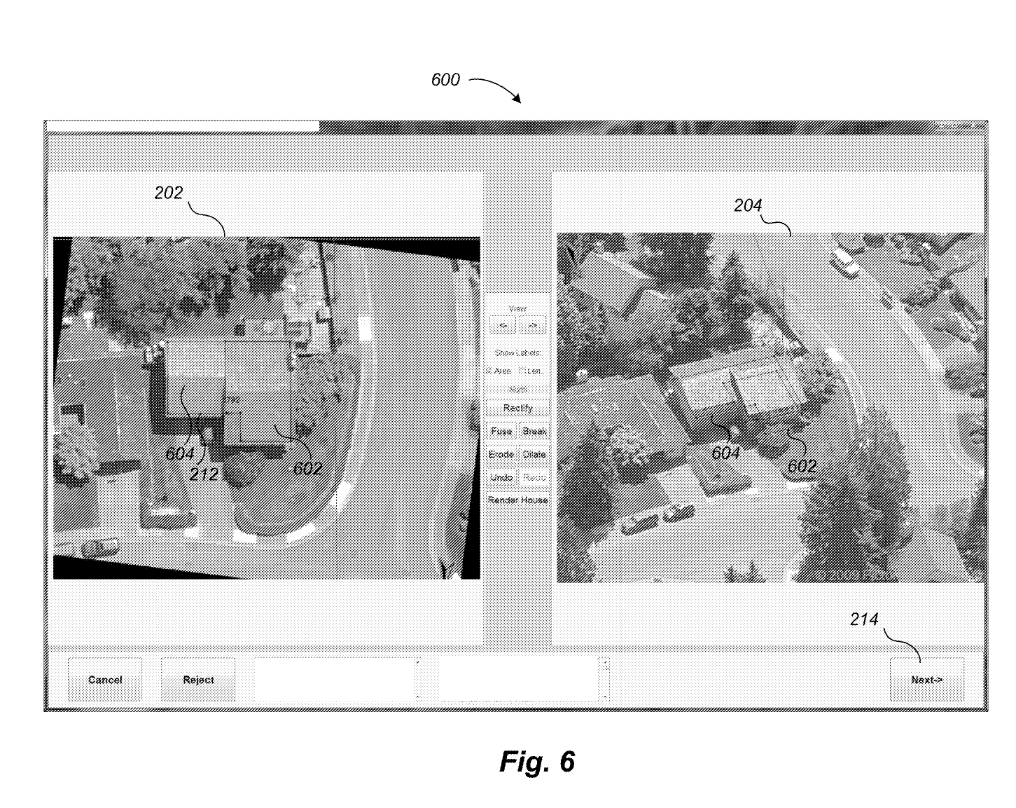

FIG. 6 is an example screenshot 600 of a user interface of the system of FIG. 2 for generating floor area measurements showing the building annotated with adjusted estimated first floor and second floor area measurements, such as that estimated in the method of FIGS. 1A-1C, according to one non-limiting illustrated embodiment. For example, the user may manipulate or otherwise adjust the annotation 212, or add additional annotations to represent multiple floors of the building as identified (manually or automatically) in the oblique view 204 of the building. Based on these adjustments, the floor area measurement estimation system may perform act 130 of the process shown in FIG. 1C to generate the estimated floor area measurement based on information received regarding a number of stories of the building. For example, the floor area measurement estimation system may receive information regarding how many stories the building has and regarding one or more sections of the roof below which one or more of the stories laterally extends. The system may then generate the estimated floor area measurement based on a total area of the one or more sections of the roof under which each of the stories extends and based on the generated estimated total roof area of the roof.

In the example embodiment shown in FIG. 6, shown is a first floor annotation 602 and a second floor annotation 604 that combined form annotation 212. The relationship between the first floor, second floor and roof can be seen form a different perspective in the oblique view 204 as the second floor annotation 604 shows that the second floor laterally extends substantially the entire length of the roof. However, the first floor annotation 602 shows that the first floor laterally extends about half way the length of the roof and the second floor due to the garage. The first floor annotation 602 and a second floor annotation 604 may be directly or indirectly manipulated and adjusted resulting in different area measurements of the floor represented by these annotations.

Also, first floor annotation 602 and second floor annotation 604 may be directly or indirectly manipulated and adjusted to account for spaces that are not to be included in the estimated floor area measurement. For example, these areas may be areas of the building that are not used for living inside the building or areas outside the building, including but not limited to: garages; attics; unfinished rooms above the garage or other unfinished spaces; covered balconies; patios, decks or porches, basements; crawl spaces; etc. This also may be performed automatically in response to a user marking or otherwise identifying such areas on the first floor annotation 602 and second floor annotation 604, or otherwise adjusting the dimensions of the sides of the first floor annotation 602 and second floor annotation 604 to “notch” out or “cut” out such areas. In some embodiments, selectable graphical user interface items are provided representing such spaces. When selected an placed on the first floor annotation 602 and second floor annotation 604, a an area corresponding to a standard size and/or shape of such a space will be removed from the first floor annotation 602 and second floor annotation 604, and the floor area measurements will be automatically adjusted accordingly.

For example, a selectable graphical user interface item representing a standard two-car garage may be selected by a user and placed in a position on the first floor annotation 604 overlaid on the image of the building corresponding to where a garage of the building is located. The floor area measurement estimation system will then subtract an area corresponding to the area of the standard two-car garage from the area of the first floor according to the position of the graphical user interface item representing the standard two-car garage on the first floor annotation 604.

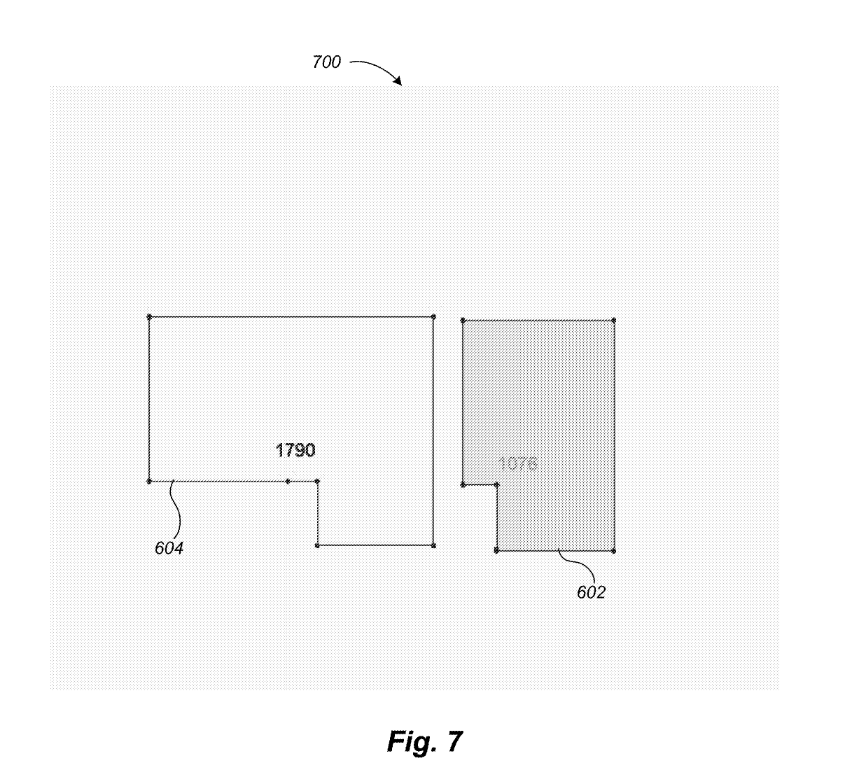

FIG. 7 is an example screenshot 700 of a user interface of the system of FIG. 2 for generating floor area measurements showing a line drawing of a top plan view of each the first and second floor of the building annotated with corresponding floor area measurements of the building shown in FIG. 6, such as that estimated in the method of FIGS. 1A-1C, according to one non-limiting illustrated embodiment. The line drawing represents the first floor annotation 602 and the second floor annotation 604 shown in FIG. 6. Note that the corresponding estimated floor areas are displayed on each annotation. These are automatically adjusted by the floor area measurement estimation system upon manipulation of the corresponding first floor annotation 602 or second floor annotation 604 by the user.

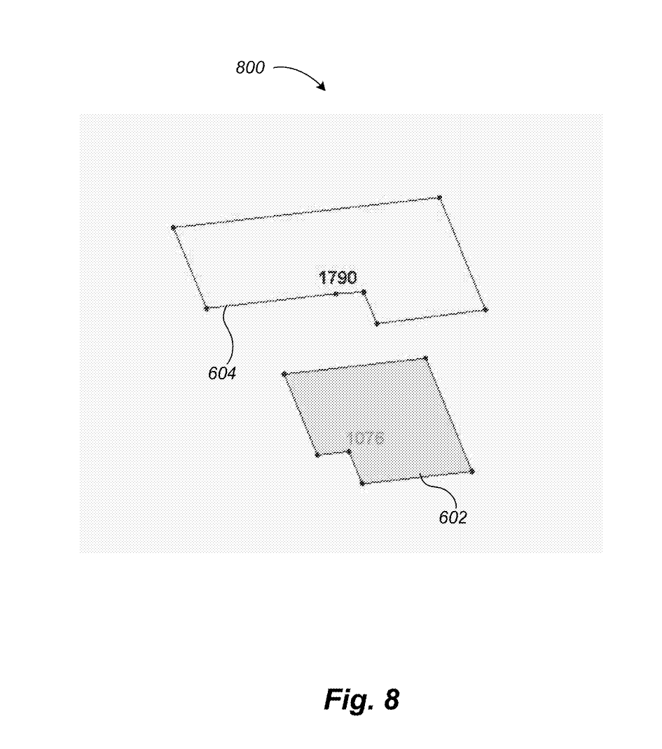

FIG. 8 is an example screenshot 800 of a user interface of the system of FIG. 2 for generating floor area measurements showing a line drawing of a top perspective view of the first and second floor of the building shown in FIG. 6 annotated with corresponding floor area measurements, such as that estimated in the method of FIGS. 1A-1C, according to one non-limiting illustrated embodiment. Shown in this manner in the graphical user interface of the floor area measurement estimation system, a user may manipulate the corresponding first floor annotation 602 and/or second floor annotation 604 and see the visual effects of the changes according to the positional relationships between the first and second floors corresponding to the oblique view 204 shown in FIG. 6.

Provided the example in FIG. 8, the total estimated floor area of the building is 2866 square feet (1076 square feet as noted on the first floor annotation 602 plus 1790 square feet as noted on the second floor annotation 604). Various reports may be generated showing the estimated areas of the various floor and/or the estimated total floor area of the building. For example, a report may be generated by the building floor area measurement estimation system or by using the data provided by the building floor area measurement estimation system that includes diagrams similar to the screenshots 700 and 800 shown in FIGS. 7 and 8, respectively either alone or overlaid on the corresponding images of the building shown in FIG. 6.

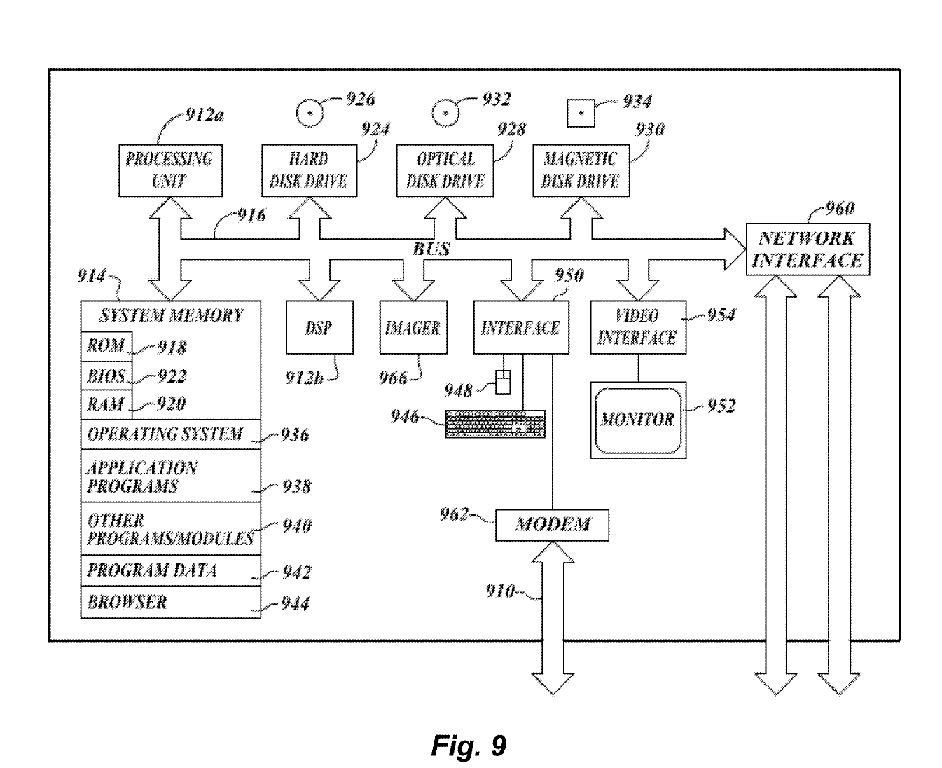

FIG. 9 is a schematic diagram of a computing environment in which systems and methods for estimation of building floor area may be implemented or of which they may be a part. For example, processes 100, 110 and 120 described above in conjunction with FIGS. 1A-1C may be performed or implemented by, for example, one or more software modules or components or any combination of suitable hardware, firmware or software components or devices including those that are a part of, stored in, or configure the computing environment of FIG. 9. Also, the graphical user interface functions and features may be performed or implemented by, for example, one or more software modules or components or any combination of suitable hardware, firmware or software components or devices including those that are a part of, stored in, or configure the computing environment of FIG. 9.

The computing environment 900 will at times be referred to in the singular herein, but this is not intended to limit the embodiments to a single device since in typical embodiments there may be more than one computer system or device involved. Unless described otherwise, the construction and operation of the various blocks shown in FIG. 9 are of conventional design. As a result, such blocks need not be described in further detail herein, as they will be understood by those skilled in the relevant art.

The computing environment 900 may include one or more processing units 912a, 912b (collectively 912), a system memory 914 and a system bus 916 that couples various system components including the system memory 914 to the processing units 912. The processing units 912 may be any logic processing unit, such as one or more central processing units (CPUs) 912a, digital signal processors (DSPs) 912b, digital video or audio processing units such as coder-decoders (codecs) or compression-decompression units, application-specific integrated circuits (ASICs), field programmable gate arrays (FPGAs), etc. The system bus 916 can employ any known bus structures or architectures, including a memory bus with memory controller, a peripheral bus, and a local bus. The system memory 914 includes read-only memory (“ROM”) 918 and random access memory (“RAM”) 920. A basic input/output system (“BIOS”) 922, which can form part of the ROM 918, contains basic routines that help transfer information between elements within the computing environment 900, such as during start-up.

The computing environment 900 may include a hard disk drive 924 for reading from and writing to a hard disk 926 (including a solid state memory device), an optical disk drive 928 for reading from and writing to removable optical disks 932, and/or a magnetic disk drive 930 for reading from and writing to magnetic disks 934. The optical disk 932 can be a CD-ROM, while the magnetic disk 934 can be a magnetic floppy disk or diskette. The hard disk drive 924, optical disk drive 928 and magnetic disk drive 930 may communicate with the processing unit 912 via the system bus 916. The hard disk drive 924, optical disk drive 928 and magnetic disk drive 930 may include interfaces or controllers (not shown) coupled between such drives and the system bus 916, as is known by those skilled in the relevant art. The drives 924, 928 and 930, and their associated computer-readable storage media 926, 932, 934, may provide nonvolatile and non-transitory storage of computer readable instructions, data structures, program modules and other data for the computing environment 900. Although the depicted computing environment 900 is illustrated employing a hard disk 924, optical disk 928 and magnetic disk 930, those skilled in the relevant art will appreciate that other types of computer-readable storage media that can store data accessible by a computer may be employed, such as magnetic cassettes, flash memory, solid state drives, digital video disks (“DVD”), Bernoulli cartridges, RAMs, ROMs, smart cards, etc. For example, computer-readable storage media may include, but is not limited to, random access memory (RAM), read-only memory (ROM), electrically erasable programmable read-only memory (EEPROM), flash memory, compact disc ROM (CD-ROM), digital versatile disks (DVD) or other optical disk storage, magnetic cassettes, magnetic tape, magnetic disk storage or other magnetic storage devices, solid state memory or any other medium which can be used to store the desired information and which may be accessed by processing unit 912a.

Program modules can be stored in the system memory 914, such as an operating system 936, one or more application programs 938, other programs or modules 940 and program data 942. Application programs 938 may include instructions that cause the processor(s) 912 to perform generating digital roof models, generating roof and floor area measurements, and store and display input images or images generated by generating digital roof models and generating roof and floor area measurements, including the processes described herein. Other program modules 940 may include instructions for handling security such as password or other access protection and communications encryption. The system memory 914 may also include communications programs, for example, a Web client or browser 944 for permitting the computing environment 900 to access and exchange data including digital images, roof measurements and other building data with sources such as Web sites of the Internet, corporate intranets, extranets, or other networks and devices, as well as other server applications on server computing systems. The browser 944 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google, and Microsoft of Redmond, Wash.

While shown in FIG. 9 as being stored in the system memory 914, the operating system 936, application programs 938, other programs/modules 940, program data 942 and browser 944 can be stored on the hard disk 926 of the hard disk drive 924, the optical disk 932 of the optical disk drive 928 and/or the magnetic disk 934 of the magnetic disk drive 930.

An operator can enter commands and information into the computing environment 900 through input devices such as a touch screen or keyboard 946 and/or a pointing device such as a mouse 948, and/or via a graphical user interface in order to receive, process, store and send data on which floor area measurement estimation has been or will be performed as described herein. Other input devices can include a microphone, joystick, game pad, tablet, scanner, etc. These and other input devices are connected to one or more of the processing units 912 through an interface 950 such as a serial port interface that couples to the system bus 916, although other interfaces such as a parallel port, a game port or a wireless interface or a universal serial bus (“USB”) can be used. A monitor 952 or other display device is coupled to the system bus 916 via a video interface 954, such as a video adapter which may be configured to display images used by or generated by floor area measurement estimation as described herein. The computing environment 900 can include other output devices, such as speakers, printers, etc.

The computing environment 900 can operate in a networked environment using logical connections to one or more remote computers and/or devices. For example, the computing environment 900 can operate in a networked environment using logical connections to one or more other computing systems, mobile devices and other service providers or information servers that provide the digital images in various format or by other electronic delivery methods. Communications may be via a wired and/or wireless network architecture, for instance wired and wireless enterprise-wide computer networks, intranets, extranets, telecommunications networks, cellular networks, paging networks, and other mobile networks.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computing system for generating an estimated floor area measurement, the computing system comprising:
a memory;
a floor area measurement estimation module that is stored on the memory and that is configured, when executed, to:
receive roof measurements of a building having a roof; and
generate, based at least in part on the received roof measurements, an estimated floor area measurement of the building.

2. The computing system of claim 1 wherein the received roof measurements include roof edge measurements of the roof and the estimation module is configured to generate, based at least in part on the received roof measurements, an estimated floor area measurement based on the roof edge measurements of the roof.

3. The computing system of claim 2 wherein the generating the estimated floor area measurement based on the roof edge measurements includes:
calculating the roof edge measurements assuming each section of the roof has no slope regardless of an actual slope of each section of the roof;
using the roof edge measurements to calculate an estimated total roof area of the roof assuming each section of the roof has no slope; and
generating the estimated floor area measurement based on the calculated estimated total roof area of the roof.

4. The computing system of claim 3 wherein the generating the estimated floor area measurement based on the roof edge measurements further comprises:
subtracting an amount from one or more of the roof edge measurements corresponding to an estimated roof overhang over one or more walls of the building to obtain adjusted roof edge measurements; and
generating the estimated floor area measurement based on the adjusted roof edge measurements.

5. The computing system of claim 3 wherein the generating the estimated floor area measurement based on the roof edge measurements further comprises:
subtracting an amount from one or more of the adjusted roof edge measurements corresponding to an estimated wall width to obtain adjusted roof edge measurements; and
generating the estimated floor area measurement based on the adjusted roof edge measurements.

6. The computing system of claim 1 wherein the generating the estimated floor area measurement includes:
receiving information regarding how many stories the building has and regarding one or more sections of the roof below which one or more of the stories laterally extends;
generating an estimated total roof area of the roof assuming each section of the roof has no slope regardless of an actual slope of each of the roof sections;
generating the estimated floor area measurement based on a total area of the one or more sections of the roof under which the one or more of the stories laterally extends and the generated estimated total roof area of the roof.

7. The computing system of claim 1 wherein the received roof measurements include at least one of: a plurality of dimensional measurements of a two-dimensional outline of the roof from a top plan view of the roof and an area of the two-dimensional outline of the roof from the top plan view of the roof.

8. The computing system of claim 1 wherein the roof measurements of the building are based on at least one aerial image of the building.

9. The computing system of claim 8 wherein the at least one aerial image of the building includes a first and a second aerial image of the building on which the roof measurements are based, the first aerial image representing a substantially orthogonal view of the top of the building and the second aerial image of the building representing a view from a different angle than the substantially orthogonal view of the top of the building.

10. The computing system of claim 9 wherein the roof estimation module is configured to generate, based at least in part on the received roof measurements, an estimated floor area measurement of the building by:
determining how many stories the building has using the second aerial image of the building representing a view from a different angle than the substantially orthogonal view of the top of the building.

11. The computing system of claim 1 wherein the roof measurements include at least one of: one or more roof edge dimensions of the roof, areas of a plurality of planar roof sections of the roof, and slopes of the plurality of planar roof sections of the roof

12. The computing system of claim 1 wherein the roof estimation module is further configured to generate the roof measurements of the building.

13. The computing system of claim 12 wherein the roof estimation module is further configured to generate the roof measurements of the building based on graphical indications of roof edges of the roof made on an aerial image of the building.

14. The computing system of claim 1 wherein the roof estimation module is further configured to generate and deliver a floor area measurement estimate report that includes one or more aerial images of the building annotated with numerical values that indicate the corresponding estimated floor area measurement.

15. The computing system of claim 14 wherein the roof estimation module is further configured to generate and deliver a floor area measurement estimate report that is annotated with a floor area measurement and one or more of: slope, area, and length of edges of at least some of a plurality of planar roof sections of the roof.

16. The computing system of claim 1 wherein the roof estimation module is further configured to deliver the floor area measurement estimate in response to a request.

17. The computing system of claim 16 wherein the roof estimation module is further configured to deliver the floor area measurement estimate as part of a report including a plurality of floor area measurement estimates for a plurality of buildings in response to a request for a plurality of estimates from a single entity.

18. A computer-implemented method for generating an estimated floor area measurement, the method comprising:
calculating roof edge measurements of a roof of a building assuming each section of the roof has no slope regardless of an actual slope of each section of the roof;
using the roof edge measurements to calculate an estimated total roof area of the roof assuming each section of the roof has no slope; and
generating the estimated floor area measurement based on the calculated estimated total roof area of the roof.

19. The method of claim 18 further comprising:
receiving information regarding how many stories the building has and regarding one or more sections of the roof below which one or more of the stories laterally extends, and wherein the generating the estimated floor area measurement further includes:
generating the estimated floor area measurement based on a total area of the one or more sections of the roof under which the one or more of the stories laterally extends and based on the generated estimated total roof area of the roof.

20. The method of claim 18, wherein the generating the estimated floor area measurement based on the calculated estimated total roof area of the roof includes:
receiving information regarding floor area spaces of the building that are not to be included in the estimated floor area measurement of the building; and
generating the estimated floor area measurement based on an area corresponding to a an extent to which the spaces extend under the roof.

21. The method of claim 18, further comprising:
modifying the estimated floor area measurement to be a measurement of floor living area.

22. A computer-readable medium whose contents enable a computing system to generate an estimated floor area measurement, by performing a method comprising:
receiving a first and a second aerial image of a building having a roof, each of the aerial images providing a different view of the roof of the building;
correlating the first aerial image with the second aerial image;
generating, based at least in part on the correlation between the first and second aerial images, a three-dimensional model of the roof that includes a plurality of planar roof sections that each have a corresponding slope, area, and edges;
generating an adjusted roof model by adjusting a slope of the planar roof sections in the three dimensional model of the roof to substantially zero;
obtaining an estimated total roof area measurement based on the adjusted model; and
generating, based at least in part on the estimated total roof area measurement, an estimated floor area measurement of the building.

23. The computer-readable medium of claim 22 wherein the generating the estimated floor area measurement of the building includes:
subtracting an amount from one or more of roof edge measurements obtained from the adjusted roof model corresponding to an estimated roof overhang over one or more walls of the building to obtain adjusted roof edge measurements; and
generating the estimated floor area based on the adjusted roof edge measurements.

24. The computer-readable medium of claim 22 wherein the contents further enable a computing system to deliver the estimated floor area in response to a request.

25. A floor area measurement report produced by a process comprising:
receiving roof measurements of a building having a roof;
generating, based at least in part on the received roof measurements, an estimated floor area measurement of the building; and
electronically communicating the estimated floor area measurement.

26. The floor area report of claim 25 wherein the generating the estimated floor area measurement includes:
receiving information regarding how many stories the building has and regarding one or more sections of the roof below which one or more of the stories laterally extends;
generating an estimated total roof area of the roof assuming each section of the roof has no slope regardless of an actual slope of each of the roof sections; and
generating the estimated floor area measurement based on a total area of the one or more sections of the roof under which the one or more of the stories laterally extends and the generated estimated total roof area of the roof.
